(19) United States
(12) Patent Application Publication
(10) Pub. No.: US 2008/0056529 A1
(43) Pub. Date: Mar. 6, 2008

(54) Systems and Methods for Image Watermarking

(76) Inventor: Anoop K. Bhattacharjya, Campbell, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/470,479

(22) Filed: Sep. 6, 2006

(51) Int. Cl. G06K 9/00

(52) U.S. Cl. 382/100

(57) ABSTRACT

Systems and methods for embedding data into and/or extracting data from a digital signal, such as an image, are disclosed. Embodiments described herein utilize a set of detectable small-scale structures, or tokens, together with a large-scale layout, or modulation frames, with embedding sites for the tokens to embed the data. Embodiments for extracting the embedded data use position constraints of the modulation frames to assist in identifying the embedded tokens.

### BACKGROUND

A. Technical Field

The present invention pertains generally to digital image processing, and relates more particularly to image processing that embeds inconspicuous information into an image and that detects the embedded information. The present invention for embedding information in an image and for detecting the embedded information may be incorporated into systems and methods.

B. Background of the Invention

The proliferation of computers with increasing computational power has contributed to the growth of digital image processing. Digital images can typically be copied without concern for image degradation. Digital images can also be easily modified, enhanced, and adapted to provide high-quality images that meet a wide range of application requirements. These characteristics of digital images are also sources of concern for owners of images that wish to protect copyrights in the images or that wish to detect and identify sources of unauthorized copying.

In response to these concerns, there have been attempts to develop ways to embed information into digital signals, such as images, that can identify the owner of the digital signal or that can identify the device that was used to produce the digital signal or a copy thereof. In particular, there has been considerable effort to develop ways to embed authenticating information into images to enable subsequent proof of ownership or to enable source tracking for images produced on permanent media such as paper.

Some implementations embedded information that is clearly visible in the images. Although such methods make detection easy, it distorts the original image. Other attempts to make the embedded data more inconspicuous require extraction methods that are time consuming or require extensive computational effort to detect the embedded information. Furthermore, such methods may not reliably extract the embedded information.

What is needed are information embedding techniques that can embed data into a digital signal, such as an image, and can easily and robustly recover the embedded data.

### SUMMARY OF THE INVENTION

It is therefore an object of the present invention to provide for efficient embedding of information into a digital signal, such as an image, that is inconspicuous and for the efficient detection of the embedded information. Throughout the disclosure of the present invention, mention may be made of images conveyed by digital signals. It is anticipated that the present invention may have greater advantages in image processing applications; however, the principles of the present invention are not limited to images and may be applied to a wide range of items, including text and audio.

Embodiments of the present invention may use a combination of easily detectable small-scale structures together with information-bearing large scale layout of these structures to embed data in an image. The small-scale features decouple display characteristics (for example, printer noise, screen frequency, laser versus ink jet characteristics, and the like) from the rest of the embedding process. Thus, the same algorithm may be applied to different media by tuning a small number of small-scale feature parameters including, without limitation, size, pattern, modulation amount, type of modulation, and layout. In an embodiment, a graph-based technique may be used to recover the embedded data from the modulated image. In embodiments, the present invention provides robustness against limited image scaling, pixel color, and pixel position noise.

According to one aspect of the present invention, a method for embedding data into an image may comprise transforming the data into a set of ordered tokens, wherein each token comprises a modulation pattern and represents a value, generating a modulation frame with embedded tokens by positioning the set of ordered tokens into a set of ordered embedding sites of a modulation frame, the modulation frame comprising a coordinate frame marker and the set of ordered embedding sites, and overlaying the modulation frame with embedded tokens over at least a portion of the image and modulating at least a portion of the image according to the modulation frame with embedded tokens.

In an embodiment, the modulation pattern of a token may comprises a first modulation region and a second modulation region, and each token in the set of tokens may have the same or substantially the same amount of modulation. In an embodiment, the amount of modulation may be modified based on the image metrics measured over the embedding frame.

In embodiments, the data may be converted into a sequence of modulation frames with embedded tokens. In an embodiment, more than one modulation frame layout may be utilized in the sequence of modulation frames. In an embodiment, the layout of embedding sites of a modulation frame may configured to possess strong autocorrelation and possess a threshold value or less of cross-correlation with another modulation frame. It shall be noted that in an embodiment, an ordering of the modulation frames in the sequence of modulation frames may be used to convey information.

In an embodiment, the image may be divided into image block and these image blocks may be analyzed to assess suitability of embedding a token or tokens within the image block regions. In an embodiment, the image blocks may be prioritized or ranked based upon suitability, such as visibility of embedded tokens or detection of embedded tokens, wherein certain image blocks are modulated in preference to lower ranked image blocks.

According to another aspect of the invention, data may be read or extracted from a modulated image by projecting colors of the modulated image along a modulation axis or axes used to embed the modulated image blocks. Each modulated image block comprises embedded tokens and a coordinate frame marker. In an embodiment, some or all of the coordinate frame markers in the modulated image may be identified and may be used to rotate, scale, or rotate and scale the modulated image. In an embodiment, the coordinate frame marker may be used to align a modulation frame to a modulated block to detect the embedded tokens within the modulated block that align with the set of ordered embedding sites of the modulation frame. The detected embedded tokens may be identified and converted into data.

In an embodiment, the method of converting the embedded tokens into data may comprise, for each embedded token, assigning an order to the embedded token based upon its position within the ordered embedding sites of the modulation frame, correlating the embedded token to a value using a set of matched filters to identify the embedded token, and ordering the value into a set of values wherein the order of the value in the set of values is determined by the order assigned to the embedded token with which it was correlated. In an embodiment, additional processing may occur, such as converting between data formats.

In an embodiment, graph-based searching may be used to match a modulation frame from a plurality of modulation frames to a modulated image block by assessing the correlation of the modulated frame's set of embedding sites and modulated regions within the image block.

It should be noted that techniques of the present invention may be implemented in any device or system that receives, captures, generates, or displays an image, including without limitation, a computer, a digital camera, a mobile telephone, a personal data assistant (PDA), a portable or mobile computer, a printer, a scanner, a multimedia device, and the like. In an embodiment, embedding techniques may be implemented in an image generation device (such as, for example, a computer system, a camera, a printer, and the like) by applying the watermark to a digital signal, such as digital image data representing the image. In an embodiment, the watermark/modulation extracting or reading techniques may be implemented in, but not limited to, a scanning or copying system or any image receiving device (such as a computer system, any device capable of displaying the image).

In an embodiment, an apparatus for embedding data into an image may comprise a converter that transforms the data into a set of ordered tokens and an image modulator that generates a modulation frame with embedded tokens by positioning the set of ordered tokens into a set of ordered embedding sites of a modulation frame, and that overlaying the modulation frame with embedded tokens over at least a portion of the image and modulating the portion of the image according to the modulation frame with embedded tokens.

In an embodiment, the image modulator may generate a sequence of modulation frames with embedded tokens by positioning tokens from the set of ordered tokens into the embedding sites of a sequence of modulation frames.

An apparatus for reading data embedded in an image may comprise an image adjustor that projects colors of the image along a modulation axis or axes used to embed the data, a modulation detector that identifies the coordinate frame markers of the modulation frames, and a graph-based analyzer that uses the coordinate frame markers to align the modulation frames to the modulated blocks to detect the embedded tokens within the modulated image, and a converter that converts the embedded tokens into data.

Aspects of the present invention may be implemented in a wide variety of ways including software, hardware, firmware, or combinations thereof. For example, the functions to practice various aspects of the present invention may be performed by components that are implemented in a wide variety of ways, including discrete logic components, one or more application specific integrated circuits (ASICs), and/or a program or programs of instructions for execution by one or more program-controlled processors. It shall be noted that the manner in which the present invention is implemented is not critical.

Some features and advantages of the invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. (“FIG.”) 1 illustrates an exemplary method for embedding data into an image according to an embodiment of the invention.

FIG. 2 illustrates an exemplary method for creating a modulation frame, or sequences of frames, with embedded tokens according to an embodiment of the invention.

FIGS. 3A and 3B depict two exemplary sets of tokens according to embodiments of the invention.

FIG. 4 depicts an exemplary modulation frame comprising a set of ordered embedding sites and a coordinate frame marker according to an embodiment of the invention.

FIG. 5 depicts an exemplary modulation frame with embedded tokens and a coordinate frame marker according to an embodiment of the invention.

FIG. 6 depicts illustrates an exemplary method for embedding data into an image according to an embodiment of the invention.

FIG. 7 depicts, for illustration purposes, an image into which data may be embedded according to an embodiment of the invention.

FIG. 8 depicts an exemplary modulated image, which has been adjusted for illustration purposes to reveal the embedded tokens, according to an embodiment of the invention.

FIG. 9 illustrates an exemplary method for extracting or needing data from a modulated image according to an embodiment of the invention.

FIG. 10 depicts an exemplary modulated image, which has been adjusted to reveal the embedded tokens, according to an embodiment of the invention.

FIG. 11 illustrates an exemplary modulated image with regions identified that may potentially be embedded tokens according to an embodiment of the invention.

FIG. 12 illustrates an exemplary modulated image with the identified embedding sites of a modulation frame overlaying a portion of a modulated image to detect embedded tokens according to an embodiment of the invention.

FIG. 13 illustrates an exemplary method for converting the detected embedded tokens into data or a portion of the data according to embodiments of the invention.

FIG. 14 illustrates an exemplary system according to an embodiment of the invention.

### DETAILED DESCRIPTION OF THE PREFERRED EMBODIMENTS

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems and devices including camera, scanners, printers, computers, mobile devices with display and/or camera capabilities, multimedia devices, and the like. The embodiments of the present invention may be implemented in software, hardware, firmware, or combinations thereof. Structures and devices shown below in block diagram are illustrative of exemplary embodiments of the invention and are meant to avoid obscuring the invention. Furthermore, connections between components and/or modules within the figures are not intended to be limited to direct connections. Rather, data between these components and modules may be modified, re-formatted, or otherwise changed by intermediary components and modules.

Reference in the specification to “one embodiment” or “an embodiment” means that a particular feature, structure, characteristic, or function described in connection with the embodiment is included in at least one embodiment of the invention but may be in more than one embodiment. The appearances of the phrase “in one embodiment” or “in an embodiment” in various places in the specification are not necessarily all referring to the same embodiment.

Digital watermarking involves placing data, which may be hidden, within a digital signal. One purpose for watermarking a digital file may be to mark the digital file for copyright purposes. For example, the embedded data may include information pertaining to the origin of the file or to the author of the file. Data may also be placed within a digital signal for cryptographic or steganographic purposes. Cryptography involves the encrypting information so that others may not readily access the information unless they are able to decrypt the information. Steganography involves the art or practice of concealing information within a message, file, or image. One distinction between cryptography and steganography is that in cryptography, the existence of the message itself is typically not disguised, but the content is encrypted or obscured so that it is not readily understandable. In steganography, an individual may not be aware that information is concealed within the file and that information may or may not be encrypted. It shall be understood that the present invention may be utilized for any of these purposes, and the term “watermarking” shall be understood to encompass each of the foregoing purposes for embedding data into a digital signal regardless of the intended purpose or purposes.

Systems and methods are disclosed for embedding data as invisible or nearly invisible marks in a digital signal and for detecting the embedded data in the digital signal. Such embedded data may be referred to as a “watermark.” It shall be noted that the embodiments of the method employ a scheme that allows fast, robust embedding and retrieval of the watermark without extensive search over image orientations and scales.

A. Embedding Data

FIG. 1 illustrates an exemplary method for embedding data into an image according to an embodiment of the invention. As depicted in FIG. 1, the data to be embedded is transformed (110) into one or more modulation frames with embedded tokens. In embodiments, one or more tokens arranged in one or more specific geometric patterns within a modulation frame may be used to represent each input symbol to be embedded in an image.

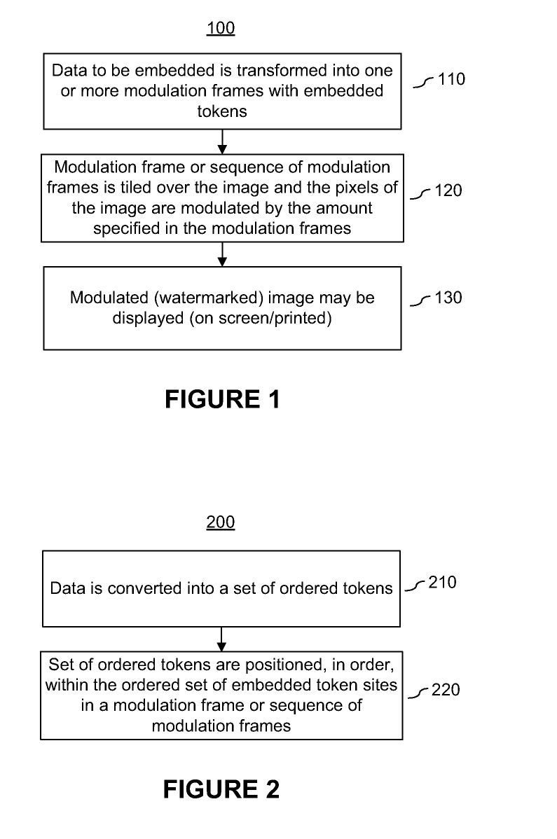

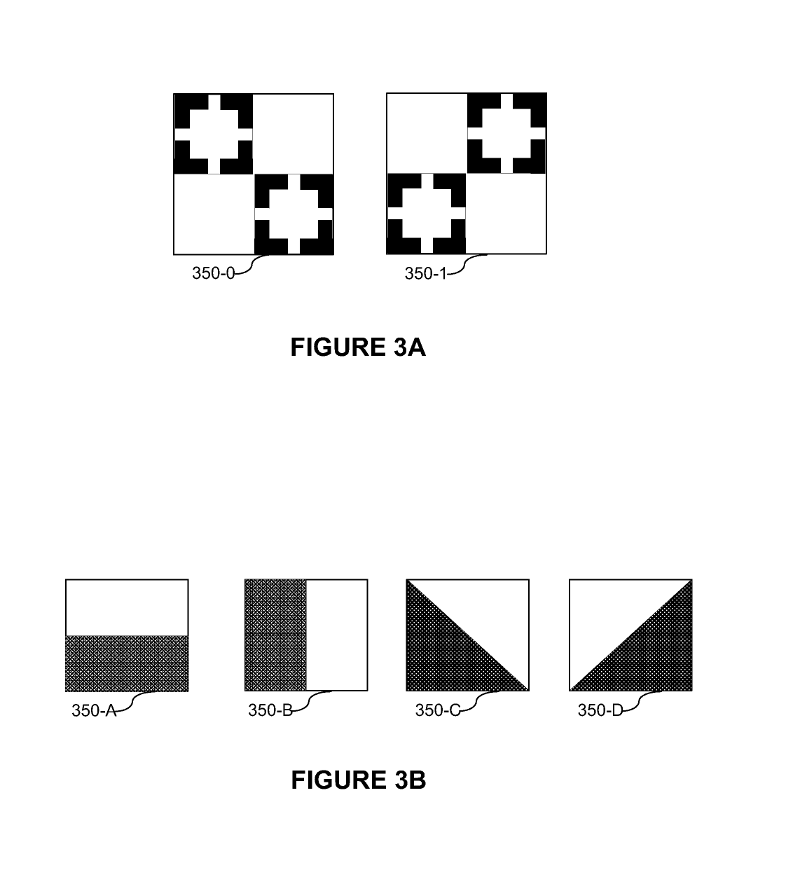

In an embodiment, the data to be embedded may be transformed into one or more modulation frame with embedded tokens. FIG. 2 illustrates an exemplary method for creating a modulation frame, or sequences of frames, with embedded tokens according to embodiments of the invention. As illustrated in FIG. 2, the data that is to be embedded may be converted (210) into a series or set of ordered tokens. The tokens used to represent the data may be selected from a set of tokens, wherein each token within the set of tokens has a modulation pattern and an associated value. FIGS. 3A and 3B depict two embodiments of sets of tokens, wherein each token 350-x has a modulation pattern and an associated value. Illustrated in FIG. 3A is an exemplary set of tokens comprising two tokens 350-0 and 350-1. In an embodiment, the value associated with one token may be “0” and the value associated with the other token may be “1.” In such a configuration, the data, if in binary format, may be converted into a set of ordered tokens that corresponds to the binary data. In an embodiment, if the data is not in binary format, the data may be converted into binary and then converted into a set of ordered tokens. Consider, for purposes of illustration, the following example. Assuming token 350-1 represents the value “1” and the token 350-0 represents the value “0,” the number “5” (which in binary form is “101”) may be represented as the following set of ordered tokens: 350-1, 350-0, and 350-1.

In an embodiment, the data may be error correction encoded prior to conversion into a set of ordered tokens. Alternatively, the data may be error correction encoded as part of the conversion process.

In an embodiment, each token possesses a modulation pattern. In an embodiment, the tokens may be a set of small-scale features that are easy to detect. These features may be simple shapes including, but not limited to, line segments, geometric shapes, patterns, and the like. For example, the sets of tokens 350 in FIGS. 3A and 3B are depicted with different modulation patterns of light and dark regions. For purposes of illustration, let the area depicted in black be denoted as A_{b} and the area depicted as white be denoted as A_{w}, then the total modulation area, A_{T}, for a token is may be defined as:

A_{T}=A_{b}+A_{w} (1)

Let the modulation change for pixels within the area depicted in black be denoted as Δb and the modulation change for pixels within the area depicted in white be denoted as Δw. The total modulation for a token may be defined as:

Δ_{b}+Δ_{w}=Δₜₒₜₐₗ (2)

In an embodiment, the amount of modulation each token possesses within a set of tokens may be the same as or similar to the other tokens within the set of tokens, thereby allowing for easier detection once the tokens have been embedded within an image. In an embodiment, the amount of modulation may be modified based on the image suitability metrics measured over the embedding frame.

In an embodiment, the modulation effect for the region on which a token is applied may be defined as:

−Δ_{b}A_{b}+A_{w}Δ_{w}=0 (3)

In an embodiment, the modulation pattern may represent modulation along one or more modulation axes, including without limitation, intensity, hue, and saturation. In an embodiment, the level of modulation and the size of the tokens may be dependent on display (screen/printer) characteristics and/or scanner characteristics. For example, laser printers with low frequency screens may need tokens with larger low-level features, noisy printers may need higher modulation, low resolution scanners may need higher modulation, and so forth.

One skilled in the art shall recognize that other configurations may be used. One skilled in the art also shall recognize that the set of tokens is not limited to two tokens. For example, FIG. 3B depicts an exemplary set of tokens comprising four tokens. Furthermore, additional tokens may be formed by reversing the shaded areas of the tokens depicted in FIG. 3B. One skilled in the art shall recognize that increasing the size of the set of tokens allows for greater amounts of data to be embedded given the same number of site locations. It shall be noted that no particular modulation pattern or set of tokens is critical to the present invention.

Returning to FIG. 2, having converted (210) the data into a set of ordered tokens, in an embodiment, the set of order tokens may be positioned (220) within the ordered set of embedding sites in a modulation frame.

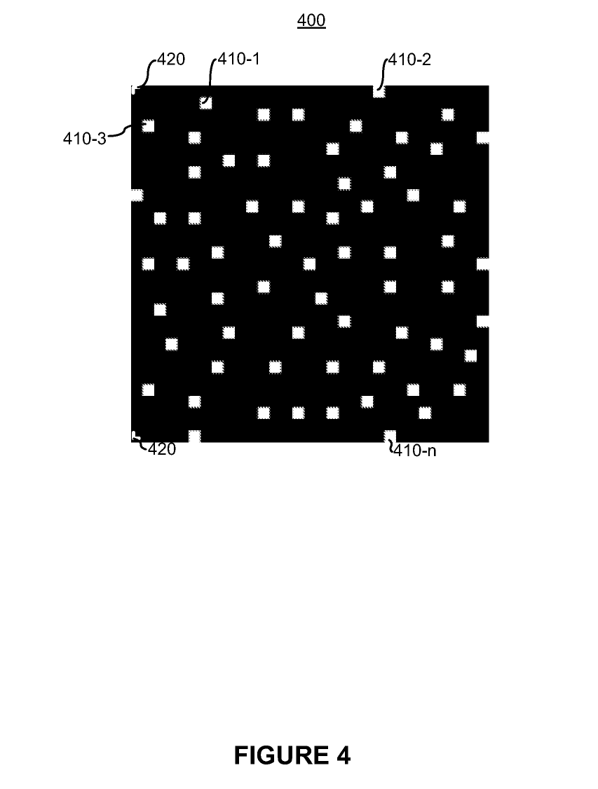

FIG. 4 depicts an exemplary modulation frame 400 according to an embodiment of the invention. In an embodiment, the modulation frame 400 comprises a set of locations or embedding sites 410 into which tokens 350 may be embedded. In embodiments, the positions of the embedding sites within a modulation frame may be randomly selected, pre-selected, and/or user selected.

In an embodiment, each location 410 receives one token. According to an embodiment, the locations or embedding sites 410 may be ordered, so that the ordering of the tokens may be preserved. For example, modulation frame 400 may have its embedding sites 410 ordered such that the first token is positioned at a first embedding site 410-1, the second token at the second embedding site 410-2, and so forth until the last position 410-n.

Consider, for purposes of illustration, the example mentioned above regarding embedding the number “5” (binary number “101”), which has been converted into the set of ordered tokens: 350-1, 350-0, and 350-1. The first ordered token, 350-1, is positioned at the first embedding site 410-1 of modulation frame 400. The second ordered token, 350-0, is positioned at the second embedding site 410-2 of modulation frame 400, and the third ordered token, 350-1, is positioned at the third embedding site 410-3 of modulation frame 400. The order of embedding sites, which is known to the device that extracts the embedded tokens, allows the embedded tokens to be properly ordered when extracting and reconstructing the data.

In an embodiment, the ordering of the embedding sites within a modulation frame may be randomly selected, pre-selected, and/or user selected. In an embodiment, the ordering of the positions within a modulation frame may vary according to a known relationship. For example, the ordering of the embedding site locations may be a function of the position of the modulation frame in a sequence of modulation frames or may be a function of its location within the image. In an embodiment, one or more embedding sites may be reserved to identify the ordering of the sites. In embodiments, the ordering of the modulation frame is known to or can be determined by the device that extracts the embedded data.

In an embodiment, a modulation frame may be adapted to have the same number of embedding sites as tokens in the set of ordered tokens used to represent the data. In an embodiment, if the modulation frame contains extra embedding sites, the set of tokens may include a “blank” or “null” token that may be positioned within the extra embedding sites.

In embodiments, the set of ordered tokens that represents the data may span more than one modulation frame. Embodiments of the present invention may utilize (220) a sequence of modulation frames to embed the data. In an embodiment, the sequence of modulation frames may utilize the same modulation frame layout. In an alternative embodiment, the sequence of modulation frames may comprise different modulation frames with different embedding site layouts. In an embodiment, the different modulation frames may be configured to have embedding site layouts that minimize overlap of embedding site locations under vertical and horizontal shifts of the modulation frames with respect to each other. That is, in an embodiment, each modulation frame may be configured to have a strong autocorrelation and very little or no cross-correlation with other modulation frames used to embed data in the image. In an embodiment, the modulation frames may be of different sizes.

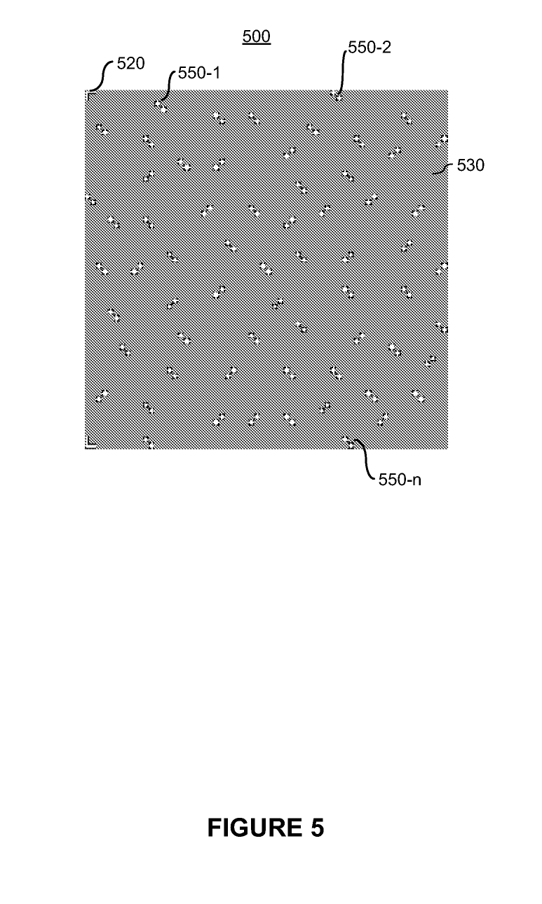

FIG. 5 depicts an exemplary modulation frame with embedded tokens according to an embodiment of the invention. The set of ordered tokens 550-x have been placed within the set of ordered location in the modulation frame 500. In embodiments, modulation frame 500 may also include a coordinate frame marker 520. As explained in more detail below with respect to extracting the embedded data, coordinate frame marker 520 may be used to identify image blocks within a modulated image that have been modulated by a modulated frame with embedded tokens. It shall be understood that a coordinate frame marker 520 shall be construed to mean a set of one or more markings in a modulated frame.

Returning to FIG. 1, the modulation frame (or sequence of modulation frames) with embedded tokens may be periodically replicated (120) over the image, or a portion thereof, and the pixels of the image are modulated by the amount specified by the modulation frame (or sequence of modulation frames). In an embodiment, the remainder of the modulation frame 530 (that is, the non-embedded token and non-coordinate frame marker portions) may have no modulation affect on the image. In an embodiment, the modulation frame (or sequence of modulation frames) with embedded tokens may be applied to the image only once. Once the image has been modulated with the modulation frame (or sequence of modulation frames) with embedded tokens, the modulated image may be displayed or printed (130).

In an embodiment, modulation may be restricted to or prioritized to image blocks with specific suitability properties to improve watermark invisibility or detection. In embodiments, the embedding method may comprise a priority-based scheme in which low-visibility regions are modulated prior to high-visibility regions. In an embodiment, if sufficient coverage has been obtained using low-visibility regions, high-visibility regions need not be embedded.

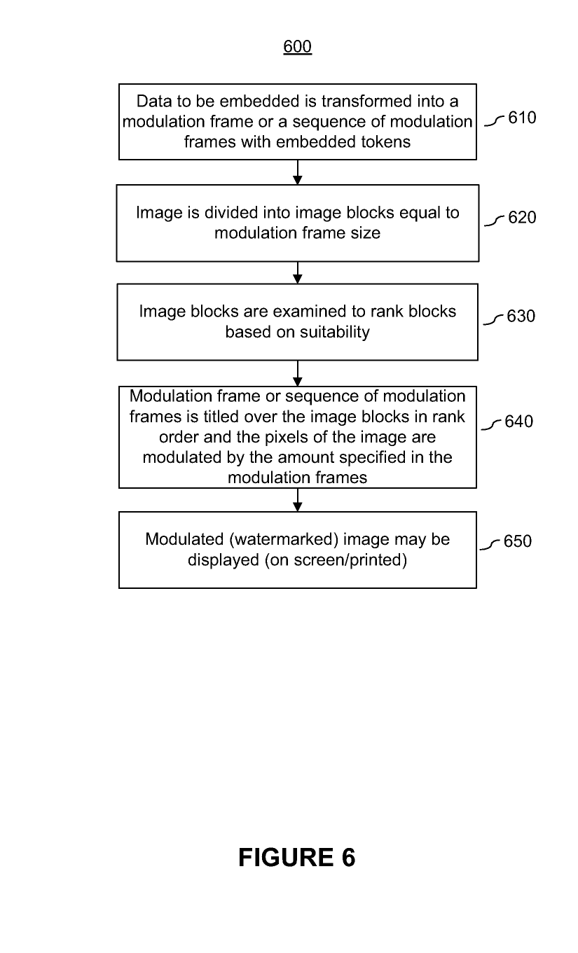

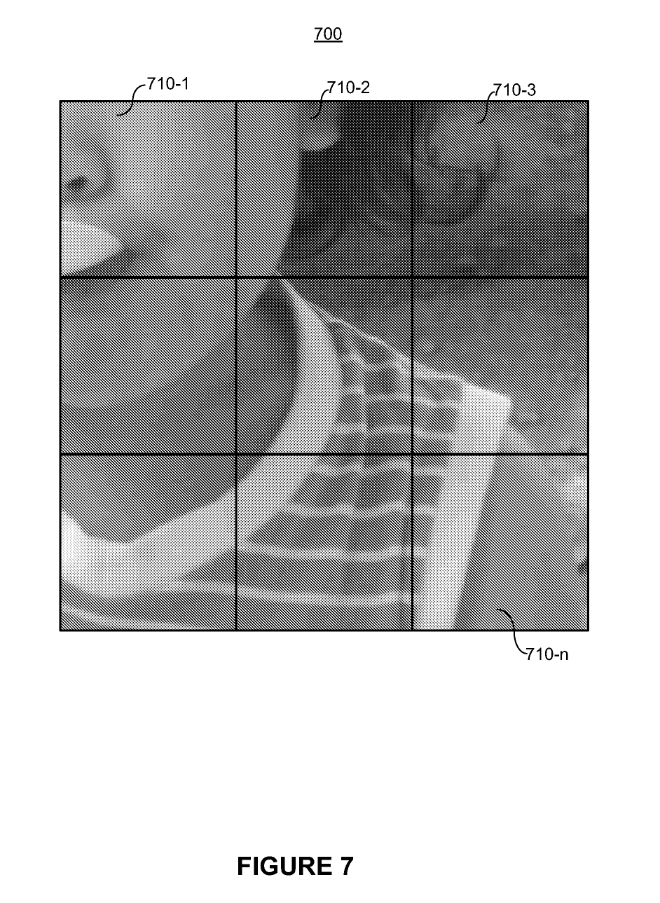

Turning to FIG. 6, depicted in an embodiment of a method to increase the invisibility or detection of embedded tokens within an image. Data to be embedded may be transformed (610) into a sequence of one or more modulation frames with embedded tokens. The input image may be divided into image blocks. In an embodiment, the image blocks are (620) of equal size to the modulation frames. FIG. 7 depicts, for illustration purposes, a portion of an enlarged input image 700 into which data may be embedded. Input image 700 may be divided into a plurality of image blocks 710 for examination to determine suitability for embedding data. In the depicted example, image block 710-2 may be ranked low because the hair in the image block may yield a noisy image block making it difficult to extract embedded tokens from that image block. Returning to FIG. 6, these blocks may be examined (630) and ranked according to one or more suitability metrics. The suitability metrics may include, but are not limited to, color, pattern, noise level, luminance, or based on any of the modulation parameters used to embed the token. In an embodiment, smooth, mid-tone region may be preferred for embedding data. In an embodiment, the sequence of modulations frames are tiled (640) over the image blocks in rank order, and the pixels of each image block are modulated (640) by the amount specified by the corresponding modulation frame with embedded tokens. By embedding the data starting with the most preferred image blocks, if not all of the image blocks are required to embed the data, the least preferred image blocks will not be utilized. Additionally or alternatively, only those image blocks that exceeded a rank threshold value of suitability may be used. In an embodiment, the amount of modulation of the embedded tokens may be modified within the image based on the image suitability metrics measured over an embedding frame. For example, in smooth regions the amount of modulation of an embedded token or tokens may be decreased and in noisy regions, the amount of modulation may be increased.

Once the data has been embedded into the image using the modulation frame or sequence of modulation frames with embedded tokens, the modulated image may be displayed (650) by displaying the modulated image on a screen or printing it with a printer.

One skilled in the art shall recognize that the ordering of the steps in the method depicted in FIG. 6 may be rearranged. In an embodiment, the image may be analyzed to identify and/or rank the image blocks (620 and 630) prior to or contemporaneous with the data being transformed into one or more modulation frames with embedded tokens.

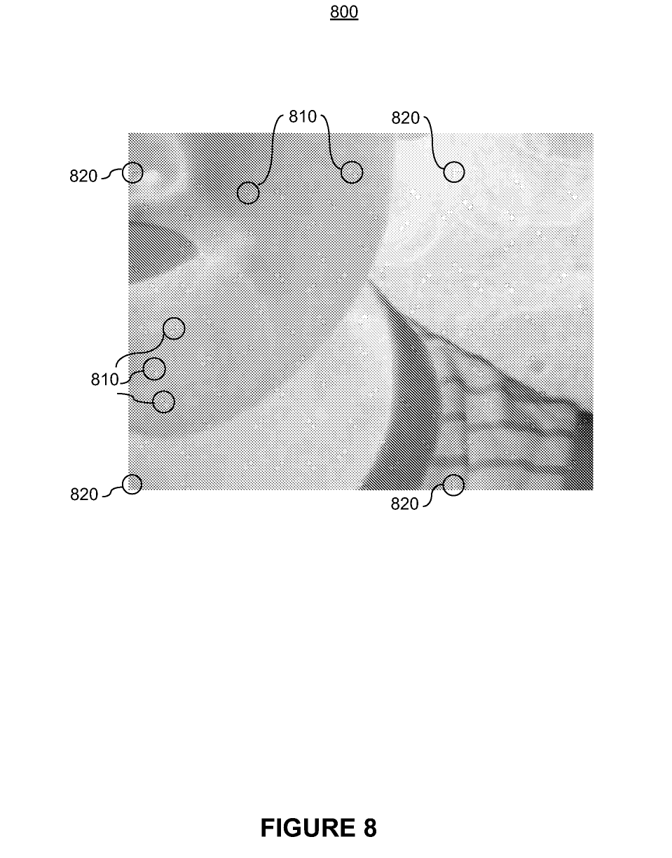

FIG. 8 depicts an exemplary modulated image containing embedded tokens 810, which image has been adjusted for illustration purposes to reveal the embedded tokens. In the depicted embodiment, the tokens were embedded by modulating the intensity of the pixels. The image 800 in FIG. 8 has been adjusted along an intensity axis to reveal the modulation. Depicted in FIG. 8, for purposes of illustration, are some of the embedded tokens 810 and some of the coordinate frame markers 820.

B. Retrieving or Reading the Embedded Data

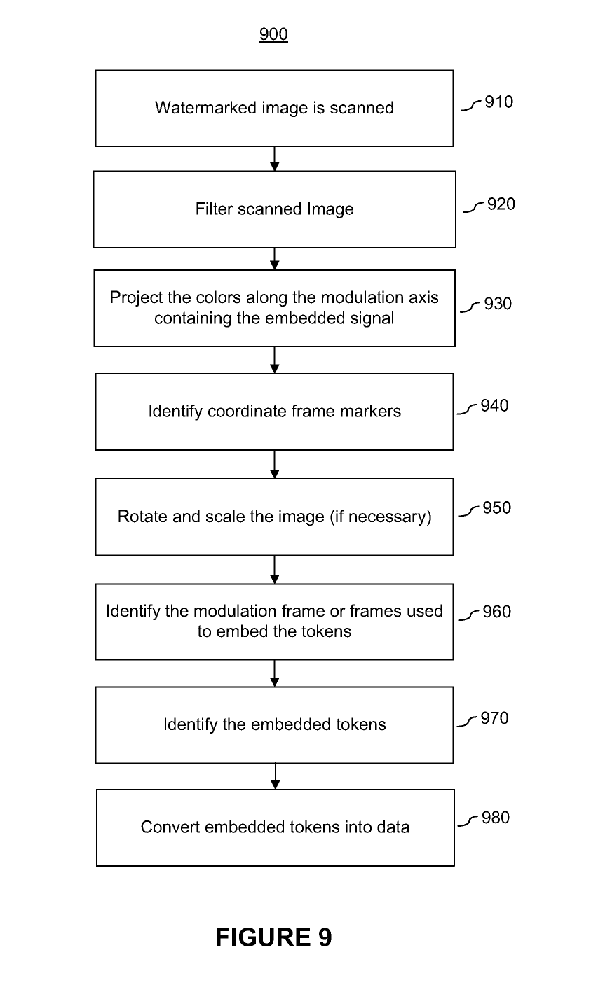

FIG. 9 illustrates an exemplary method for extracting or reading the data from a modulated image according to an embodiment of the invention. In an embodiment, if the modulated image was previously printed, the print copy may be scanned (910) to obtain a digital representation of the watermarked image. The scanned image may be filtered (920) to smooth the scanned image. In an embodiment, the filter may be a band-pass filter. If the watermarked image is already in digital form, scanning and filtering may not be performed.

In an embodiment, to aid detection of the embedded data, a mean of the image may be obtained and the image may be subtracted from the mean of the image. In an embodiment, the mean may be computed locally over the support of the embedding site by using a filter with a kernel that has the same size as an embedded token. This step helps identify the areas of modulation. In an embodiment, the foregoing step may be performed on one or more portions of the images.

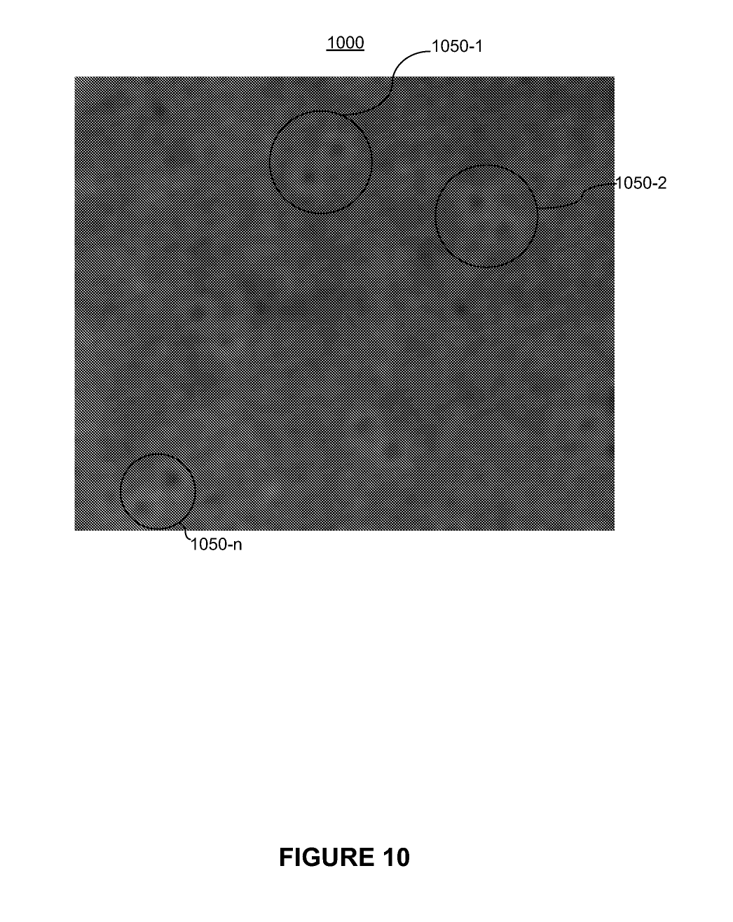

In an embodiment, to aid detection of the embedded data, the modulated image may be adjusted by projecting (930) the image colors along the modulation axis or axes used to embed the tokens. For example, the digital image may be projected into an HSI (hue-saturation-intensity) color space and the image information along the intensity axis may be examined to identify modulation. It shall be understood that the present invention may be applied to grey-scale images as well. FIG. 10 depicts an exemplary modulated image 1000, which has been adjusted to reveal potentially modulated regions, including embedded tokens 1050.

In an embodiment, the image may be examined to identify (940) the coordinate frame markers. In an embodiment, the coordinate frame markers may be identified using edge detection or a matched filter.

In embodiments, the coordinate frame markers may be used to identify orientation. In an embodiment, the configuration of the coordinate frame marker, which may include (but is not limited to) one or more of the following: shape, pattern, modulation pattern, and location, may identify image orientation. For example, in one embodiment, a single coordinate frame marker may be placed in one corner of a modulation frame to identify orientation. In an alternative embodiment, a coordinate frame marker may comprise two or more markers placed in specific locations, for example the top left and bottom left corners, to identify the orientation of the image or the modulation frame. Alternatively, the modulated image may be searched over different orientations.

Coordinate frame markers in the modulated image may be beneficial for at least three reasons. First, as discussed above, the coordinate frame marker may be used to identify orientation of a modulated portion of the image or of the entire image. Second, the coordinate frame markers may be configured to be readily detected; thus, making it fast and easy to find the modulated image blocks within the image. Consider for example, the coordinate frame markers 820 depicted in FIG. 8. In an embodiment, by performing a matched filtered search for the coordinate frame markers, the modulated image blocks may be readily identified. Third, particularly in the embodiments in which the watermarked image has been scanned, the coordinate frame markers may be used to determine whether the image should be rotated, scaled, or both rotated and scaled (950). Because the size and shape of the modulation frames are known, by examining the locations of the coordinate frame markers, rotation and scaling factors, if necessary, may be calculated. Rotation and scaling functions are well-known to those skilled in the art, and no particular rotation or scaling function or functions are critical to the present invention.

In an embodiment, the image may be examined to determine if modulated regions correlate with the modulations of the embedded tokens, or portion of the tokens. Regions possessing modulation that are within a threshold value of the modulation of the tokens may be noted. In an embodiment, these regions may be identified without identifying the token.

Consider, for example, that each token modulates, by making lighter, a certain percentage of the pixels in the token region. The image may be examined by identifying those regions of the image that have the same or similar amounts of lighter pixels in a region of the same or similar size as a token. One skilled in the art shall recognize that this process may also be applied by using the modulation of a portion of the tokens.

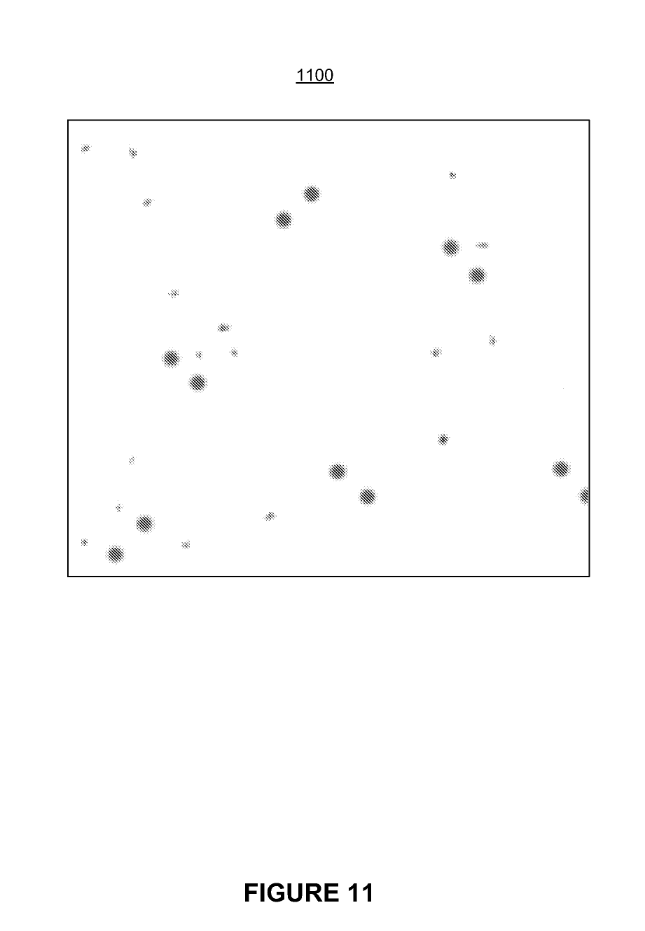

Consider, for example, the image 1100 depicted in FIG. 11. FIG. 11 illustrates an exemplary modulated image 1100 wherein modulated regions have been identified within image 1000 in FIG. 10, and those modulated image regions appear as dots on the image 1100. In an embodiment, a matched filter or filters may be used to identify regions matching a known low-scale feature or features of the tokens. In the illustrated example of FIG. 11, a matched filter correlated to a circular feature that is darker than its surrounding may be used to identify the modulated regions. This matched filter may represent a feature of the tokens or a portion of the tokens. For example, the tokens may comprise two or more circular regions in different orientations, but the matched filter may search for only one circular region. In an embodiment, using low-scale features with rotational symmetry precludes the need for image rotation operations during the step of identifying modulated regions. In an embodiment, the matched filters used to identify the modulated regions may be correlated to the set of tokens and may be used to identify the embedded tokens.

In embodiments, the matched filter responses may be grouped into clusters that contain embed tokens. In an embodiment, embed tokens may not be reliably identified at this stage because of interfering watermarks or noise in the image.

It is possible that some regions identified above may possess the same or similar modulation as the tokens, but are not, in fact, embedded tokens. In an embodiment, additional constraints, such as position constraints, may be used to assist in identifying the embedded tokens. In an embodiment, the modulation frame or frames used to embed the tokens may be used to apply position constrains and help identify the embedded tokens.

In an embodiment, graph-based searching using the modulation frame or frames may be used to resolve ambiguities regarding the modulated image regions and extract the embedded tokens based on knowledge of the modulation frame sites. Graphed-based filtering may be used to identify (960) which modulation frame should be matched to a modulated image block because, given the auto- and cross-correlation properties of the modulation frames, only one modulation frame will yield a high correlation between modulation sites and modulated image regions. In an embodiment, the modulation frame that yields the highest number of matches between modulation sites and modulated regions may be selected as the modulation frame for that image block. It should be noted that the use of clustering to group matched-filter responses into embed tokens and embedded position nodes provides robustness against pixel position noise.

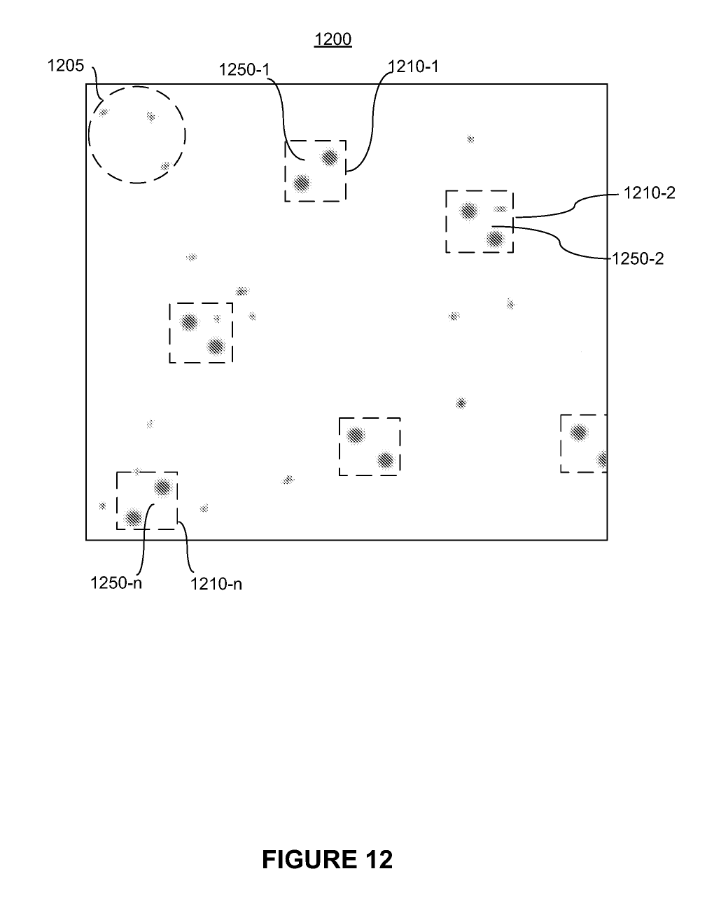

Consider, for purposes of illustration, the image 1200 depicted in FIG. 12. FIG. 12 depicts the image shown in FIG. 11 but with an overlay of embedding sites 1210 of a modulation frame. Notice that there is a high correlation between modulation regions 1250-x and modulation sites 1210-x. It should also be noted that modulated regions that are not embedded tokens are excluded because they fail the position restriction imposed by the modulation frame. For example, modulated region 1205 is excluded because it is not within an embedding site location of the modulation frame.

In an embodiment, the coordinate frame markers may be used to help align the modulation frames to the image blocks during the graph-based searching. It should be noted that using graph-based searching allows the image to not have to be aligned or registered to an external reference frame, such as a scanner grid.

In an embodiment, once the modulation frame for the image block has been identified, the embedded tokens may be identified (970) and the data may be recovered (980). Provided below is an exemplary method for converting the embedded tokens into data.

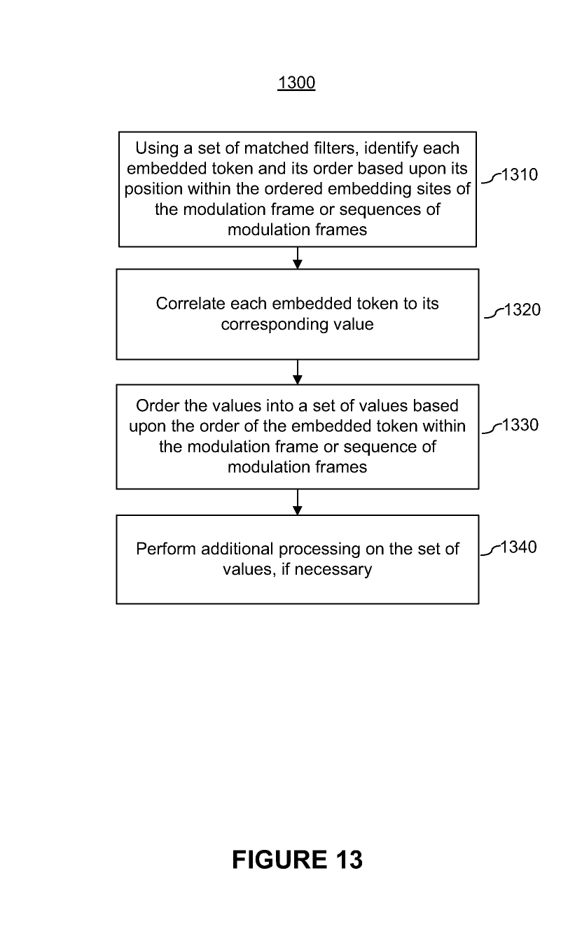

FIG. 13 an exemplary method for converting the embedded tokens into data according to an embodiment of the invention. Matched filters may be applied to the site locations of the modulation frame to identify (1310) the tokens embedded in the modulated image block, and the identified embedded tokens may be correlated (1320) to their respective values.

Consider, for example, the image 1200 in FIG. 12. Matched filters correlated to the set of tokens may be applied (1310) to each of the site locations 1210-x of the modulation frame to identify which tokens from the set of tokens have been embedded. Having identified a token, its corresponding value is also known (1320).

Because the site locations of the modulation frame are ordered, each value of an identified token may be ordered (1330) into a set of values based upon the position of its corresponding token within the ordered embedding sites of the modulation frame. For example, the value corresponding to the embedded token 1250-1 may be ordered first since the embedded token 1250-1 resides at the first embedding site, site 1210-1; the value corresponding to the embedded token 1250-2 may be ordered second since the embedded token 1250-2 resides at the second embedding site, site 1210-2, and so forth for all of the embedded token 1250-x. It should be noted that embodiments of the present invention may include the use of sequences of modulation frames and that the order may span more than one modulation frame. In an embodiment, the order of the modulation frames may be pre-determined. Alternatively, one or more of the embedded sites locations of a modulation frame or frames may be reserved to identify the ordering of the modulation frame or frames.

In an embodiment, the set of values may be the data. Alternatively, the set of values may undergo additional processing (1340) to obtain the data. For example, if the set of values represents binary data, that binary data may be converted into another format, including without limitation, alphanumeric text.

As noted previously, in an embodiment, the ordering of the sequence of modulation frames may also be used to encode information. For example, if there are two different modulation frames, the sequencing of the modulation frames may be used to encode binary data. This data encoded by the sequencing of the modulation frames may represent a separate data channel that is independent of the embedded tokens, or alternatively, the data encoded by the sequencing of the modulation frames may be related to or combined with the data embedded using tokens.

One skilled in the art shall recognize that that the steps for the methods presented herein may be combined, removed, subdivided, and/or reordered. Accordingly, no single method configuration for each of the exemplary methods presented herein is critical to the present invention.

C. System Implementations

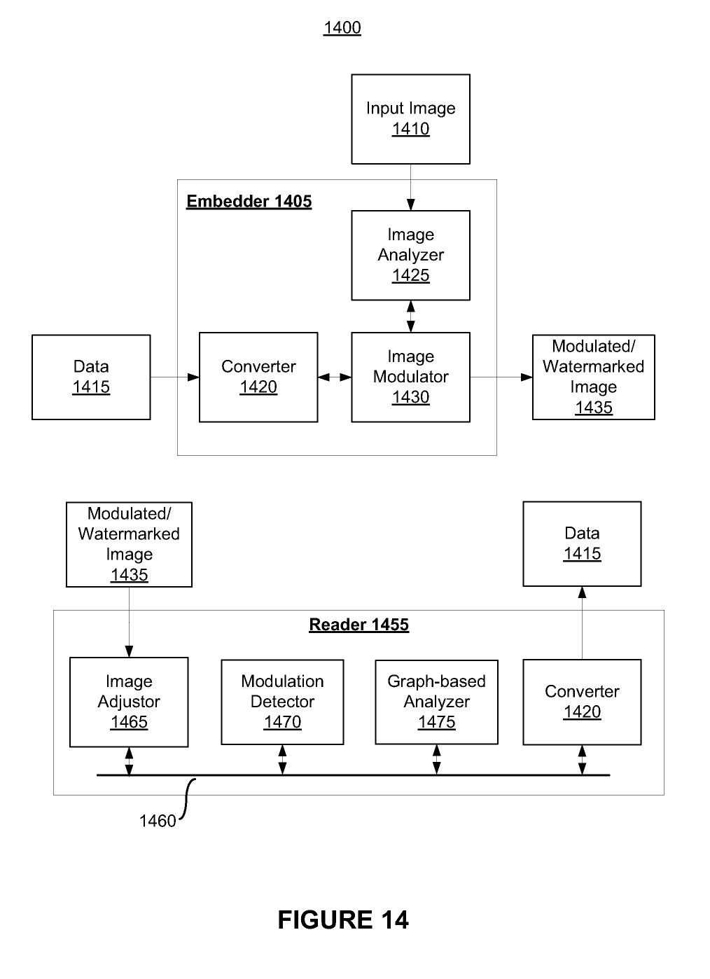

FIG. 14 depicts an embodiment of a system 1400 that comprises an embodiment of an embedder 1405 for embedding data 1415 into an image 1410 and an embodiment of a reader 1455 for extracting the embedded data from a watermarked image 1435.

Components shown in the block diagrams are illustrative of exemplary embodiments and are meant to avoid obscuring the invention. Furthermore, connections between components within the figure are not intended to be limited to direct connections. Rather, data between these components may be modified, re-formatted, or otherwise changed by intermediary systems or components. Also, additional or fewer connections may be used.

It shall also be noted that the terms “coupled” or “communicatively coupled” shall be understood to include direct connections, indirect connections through one or more intermediary devices, and wireless connections. It shall also be understood that throughout this discussion that components may be described as separate functional units, which may comprise sub-units, but those skilled in the art will recognize that the various components, or portions thereof, may be divided into separate components or may be integrated together, including integrating within a single system or component.

Embedder 1405 may comprise a converter 1420 that receives the data 1415 to be embedded and converts the data into a set of ordered tokens. In embodiments, converter 1420 may provide error encoding for the data. Alternatively or additionally, converter 1420 may convert the data from its input format into an intermediate format prior to converting the data into the set of ordered tokens. In an embodiment, converter 1420 also converts the set of ordered tokens into a modulation frame with embedded tokens or a sequence of modulation frames with embedded tokens. Alternatively, converter 1420 may provide the set of ordered tokens to image modulator 1430, which converts the set of ordered tokens into a modulation frame with embedded tokens or a sequence of modulation frames with embedded tokens.

Communicatively coupled to converter 1420 is image modulator 1430 that receives the image to be modulated 1410 and applies the modulation frame with embedded tokens or the sequence of modulation frames with embedded tokens to the image 1410. The output of the image modulator 1430 is the modulated (or watermarked) image 1435. In an embodiment, image modulator 1430 may receive information from image analyzer 1425 regarding ranking of image blocks of the image 1410 for modulation purposes. In an embodiment, image modulator 1430 may modulate the image blocks based upon the rankings.

Reader 1455 may comprise an image adjuster 1465, a modulation detector 1470, a graph-based analyzer 1475, and a converter 1420. In an embodiment, all components may be communicatively connected to a bus 1460. It shall be noted that a bus architecture is not required to practice the present invention. In an embodiment, image adjustor 1465 may receive the modulated/watermarked image 1435 and may filter the image. For example, in an embodiment, if the modulated image 1435 is obtained from a scanning process, image adjustor 1465 may filter the image 1435 using a band-pass filter to smooth the image 1435. Image adjustor 1465 may also be used to project colors of the modulated image 1435 along a modulation axis or axes used to embed the tokens.

In an embodiment, modulation detector 1470 receives the adjusted image and may use matched filtering to detect modulated regions of the image 1435. In an embodiment, reader 1455 may include an image analyzer (not shown) similar to or the same as image analyzer 1425 in embedder 1405 that analyzes the modulated image 1435 to provide ranking information. This ranking information may be used by modulation detector 1470 and/or graph-based analyzer 1475. For example, in embodiments where image blocks must exceed a certain threshold rank value, image blocks within the modulated image 1435 that do not exceed the rank value may be ignored.

In an embodiment, modulation detector 1470 detects coordinate frame markers within the modulated image 1435, and image adjustor 1465 may rotate, scale, or rotate and scale the modulated image 1435 based on the coordinate frame markers. In an embodiment, graph-based analyzer 1475 may be used to identify which modulation frame was used to embed tokens in a modulated image block, and modulation detector 1470 may use matched filters at the modulation frame site locations to identify the embedded tokens. The identified tokens may be supplied to converter 1420 to convert the tokens back to the data 1415.

In an embodiment, embedder 1405 and reader 1435 may reside or operate within the same device or system. Alternatively, embedder 1405 and reader 1435 may not reside or operate within the same device or system.

Aspects of the present invention may be implemented in any device or system that receives, captures, generates, or displays an image, including without limitation, a computer, a digital camera, a mobile telephone, a personal data assistant (PDA), a portable or mobile computer, a printer, a scanner, a multimedia device, and the like. Furthermore, within any of the devices, aspects of the present invention may be implemented in a wide variety of ways including software, hardware, firmware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application-specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the scope of the appended claims.

I claim:

1. A method for embedding data into an image comprising a plurality of pixels, the method comprising:
transforming the data into a set of ordered tokens, wherein each token comprises a modulation pattern and represents a value;
generating a modulation frame with embedded tokens by positioning the set of ordered tokens into a set of ordered embedding sites of a modulation frame, the modulation frame comprising a coordinate frame marker and the set of ordered embedding sites; and
overlaying the modulation frame with embedded tokens over at least a portion of the image and modulating the at least a portion of the image according to the modulation frame with embedded tokens.

2. The method of claim 1 wherein the modulation pattern of a token comprises a first modulation region and a second modulation region.

3. The method of claim 1 wherein the step of:
generating a modulation frame with embedded tokens by positioning the set of ordered tokens into a set of ordered embedding sites of a modulation frame, the modulation frame comprising a coordinate frame marker and the set of ordered embedding sites;
overlaying the modulation frame with embedded tokens over at least a portion of the image and modulating the at least a portion of the image according to the modulation frame with embedded tokens,
comprise the steps of:
generating a sequence of modulation frames with embedded tokens by positioning each token from the set of ordered tokens into an embedding site of a sequence of modulation frames, each modulation frame comprising a coordinate frame marker and a set of ordered embedding sites; and
overlaying the sequence of modulation frames with embedded tokens over at least a portion of the image and modulating the at least a portion of the image according to the sequence of modulation frames with embedded tokens.

4. The method of claim 3 wherein the sequence of modulation frames with embedded tokens was generated using a plurality of modulation frames, wherein the modulation frames from the plurality of modulation frames have different sets of ordered embedding sites.

5. The method of claim 4 wherein each modulation frame from the plurality of modulation frames possesses a threshold value or less of cross-correlation with another modulation frame from the plurality of modulation frames.

6. The method of claim 4 wherein an ordering of the plurality of modulation frames in the sequence of modulation frames conveys information.

7. The method of claim 1 further comprising the steps of:
analyzing regions of the image to assess suitability of embedding a token or tokens within the regions; and
prioritizing the overlaying of the modulation frame with embedded tokens to regions of the image based upon suitability.

8. A computer-readable medium comprising one or more sequences of instructions which, when executed by one or more processors, cause the one or more processors to perform at least the steps of claim 1.

9. A method for extracting data embedded in an image comprising:
projecting colors of the image along a modulation axis used to embed a modulated block, which modulated block comprises embedded tokens and a coordinate frame marker, and wherein each embedded token represents a value;
identifying the coordinate frame marker;
using the coordinate frame marker to align a modulation frame, comprising a set of ordered embedding sites, to the modulated block to detect the embedded tokens within the modulated block that align with the set of ordered embedding sites; and
converting the embedded tokens into data.

10. The method of claim 9 wherein the step of converting the embedded tokens into data comprises the steps of:
for an embedded token:
correlating the embedded token to a value using a set of matched filters to identify the embedded token; and
ordering the value into a set of values wherein the order of the value in the set of values is based upon the embedding site of the modulation frame that the embedded token with which the value was correlated occupied.

11. The method of claim 9 further comprising the step of:
selecting the modulation frame from a plurality of modulation frames that, when aligned with the modulated block, possesses a correlation between its set of embedding sites and the detected embedded tokens that exceeds a threshold value.

12. The method of claim 11 wherein the image comprises a plurality of modulated blocks and the method further comprises, for each modulated blocks in the plurality of modulated blocks:
selecting a modulation frame from the plurality of modulation frames that, when aligned with the modulated block, possesses a correlation between its set of embedding sites and the embedded tokens that exceeds a threshold value and detecting the embedded tokens using that modulation frame; and
converting the embedded tokens into data.

13. The method of claim 9 further comprising the step of:
responsive to the image being a scanned image, filtering the image to reveal modulated portions within the image.

14. The method of claim 13 further comprising the step of:
identifying a coordinate frame marker in the image; and
responsive to determining, by using the coordinate frame marker, that the image should be adjusted, applying to the image at least one operation from the group of operations comprising rotation and scaling, wherein the at least one operation is applied prior to apply the modulation frame to detect the embedded tokens within a modulation block.

15. A computer-readable medium comprising one or more sequences of instructions which, when executed by one or more processors, cause the one or more processors to perform at least the steps of claim 9.

16. An apparatus for embedding data into an image comprising a plurality of pixels, the device comprising:
a converter that transforms the data into a set of ordered tokens, wherein each token comprises a modulation pattern and represents a value; and
an image modulator that generates a modulation frame with embedded tokens by positioning the set of ordered tokens into a set of ordered embedding sites of a modulation frame, the modulation frame comprising a coordinate frame marker and the set of ordered embedding sites, and that overlaying the modulation frame with embedded tokens over at least a portion of the image and modulating the at least a portion of the image according to the modulation frame with embedded tokens.

17. The apparatus of claim 16 wherein the image modulator generates a sequence of modulation frames with embedded tokens by positioning each token from the set of ordered tokens into an embedding site of a sequence of modulation frames, each modulation frame comprising a coordinate frame marker and a set of ordered embedding sites, and overlays the sequence of modulation frames with embedded tokens over at least a portion of the image and modulating the at least a portion of the image according to the sequence of modulation frames with embedded tokens.

18. The apparatus of claim 16 further comprising an image analyzer that receives the image as an input and outputs to the image modulator ranking of regions of the image, wherein the image analyzer ranks the regions of the image by assessing suitability of embedding a token or tokens within the regions.

19. An apparatus for reading data embedded in an image comprising:
an image adjustor that projects colors of the image along a modulation axis used to embed a modulated block, which modulated block comprises embedded tokens and a coordinate frame marker, and wherein each embedded token represents a value;
a modulation detector that identifies modulated regions comprising the coordinate frame marker;
a graph-based analyzer that uses the coordinate frame marker to align a modulation frame, comprising a set of ordered embedding sites, to the modulated block to detect the embedded tokens within the modulated block that align with the set of ordered embedding sites; and
a converter that converts the embedded tokens into data.

20. The apparatus of claim 19 wherein the converter converts the embedded tokens into data by performing at least the following operations comprising:
for an embedded token:
correlating the embedded token to a value using a set of matched filters to identify the embedded token; and
ordering the value into a set of values wherein the order of the value in the set of values is based upon the embedding site of the modulation frame that the embedded token with which the value was correlated occupied.
